(19) United States
(12) Patent Application Publication
(10) Pub. No.: US 2007/0208553 A1
(43) Pub. Date: Sep. 6, 2007

(54) Visual context for translation

(76) Inventors: Mark Hastings, Palo Alto, CA (US); Fuad Rashid, San Mateo, CA (US); Ben Werther, San Francisco, CA (US)

Correspondence Address: CSA LLP, 4807 SPICEWOOD SPRINGS RD., BLDG. 4, SUITE 201, AUSTIN, TX, 78759, US

(21) Appl. No.: 10/176,766

(22) Filed: Jun. 20, 2002

(51) Int. Cl. G06F 17/28

(52) U.S. Cl. 704/2

(57) ABSTRACT

A visual context displays a graphical user interface for an application without executing the application. The visual context is constructed from a definition for the graphical user interface. In one aspect, executable code for various components of the graphical user interface are extracted from the definition and written into the visual context. In another aspect, the executable code for one or more of the components is written into separate files that make up the visual context. In still another aspect, some of the components are based on templates, and the appropriate template is copied into the visual context to provide the executable code for the component.

### FIELD OF THE INVENTION

This invention relates generally to localization of computer-based applications, and more particularly to translating application terminology into local languages.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright ©2001, Siebel Systems, Inc., All Rights Reserved.

### BACKGROUND OF THE INVENTION

Interactive computer applications typically use graphical user interfaces (GuIs) to allow a user to interact with the applications. The data processed by the application is supplemented by pre-defined text, such as titles, captions, and the like. The pre-defined text is written in a human language, usually the native language of the country of the developer or a common language, such as English. When the application is destined for use in other countries, typically the text is manually translated into the various local languages as part of a process commonly referred to as “localization.” Localization must be performed for each new version of the application. However, the text may have multiple translations for each target language depending on its context. For example, the English word “account” may mean a customer in one context and a bank account in another. Therefore, accurate translation of the text is dependent upon the translator's understanding of the context in which it appears.

### SUMMARY OF THE INVENTION

A visual context displays a graphical user interface for an application without executing the application. The visual context is constructed from a definition for the graphical user interface. In one aspect, executable code for various components of the graphical user interface are extracted from the definition and written into the visual context. In another aspect, the executable code for one or more of the components is written into separate files that make up the visual context. In still another aspect, some of the components are based on templates, and the appropriate template is copied into the visual context to provide the executable code for the component. The visual context, or a reference to it, may be provided to translators to aid in the translation of text strings appearing in the graphical user interface.

The present invention describes systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

FIG. 1A is a diagram illustrating a system-level overview of an embodiment of the invention;

FIGS. 1B-C are diagrams of graphical user interface emulation file data structures for use in with the embodiment of FIG. 1A;

FIG. 2 is a flowchart of a method to be performed by the embodiment of FIG. 1A;

FIG. 3A is a diagram of one embodiment of an operating environment suitable for practicing the present invention; and

FIG. 3B is a diagram of one embodiment of a computer system suitable for use in the operating environment of FIG. 3A.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

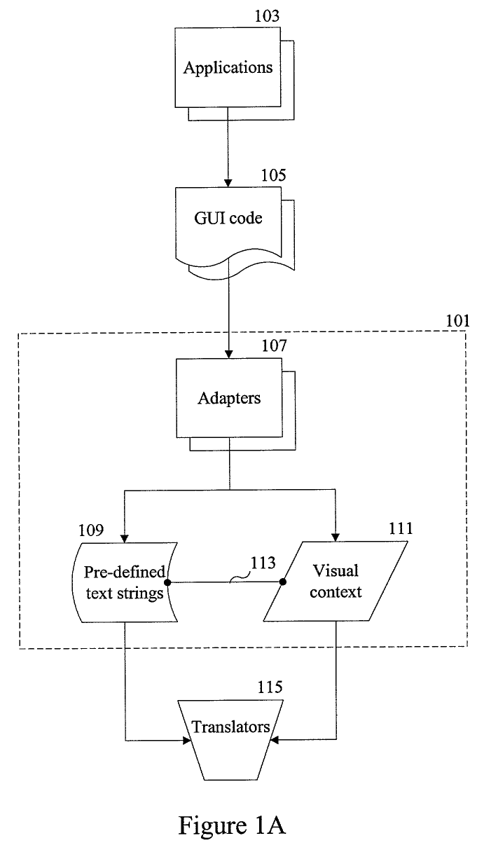

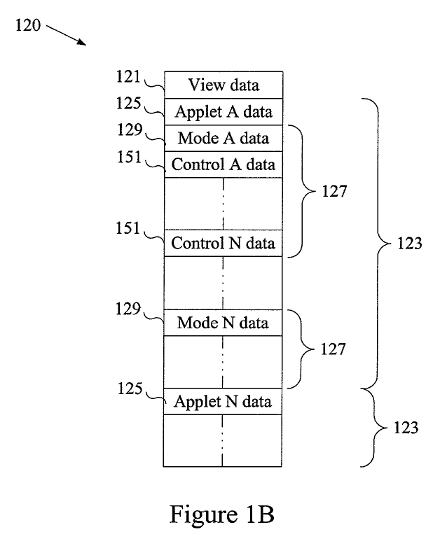

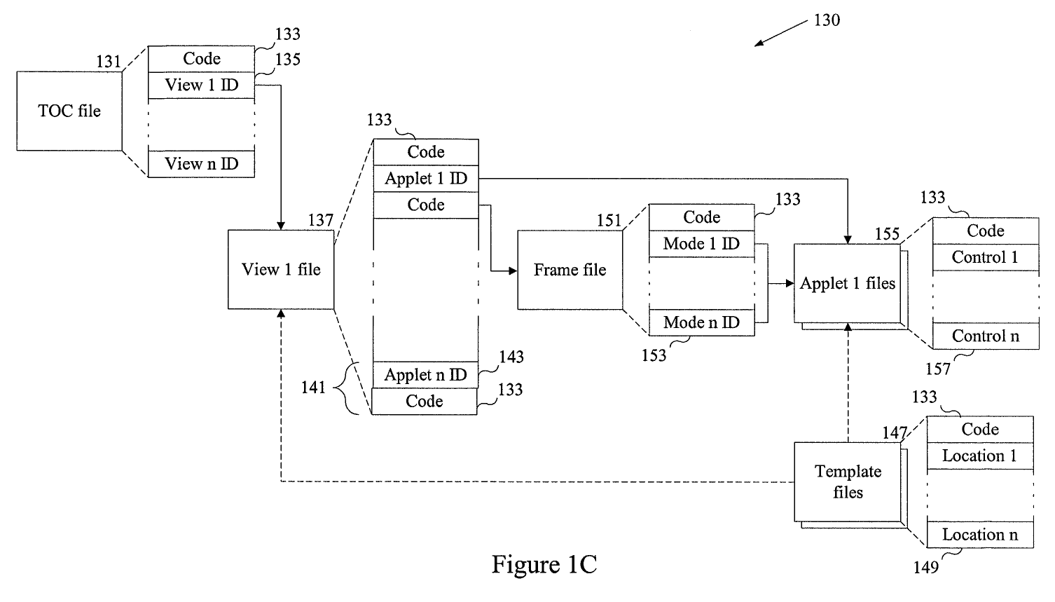

A system level overview of the operation of an embodiment of a visual context translation system 101 that facilitates localization of graphic-user interfaces (GUIs) is described by reference to FIG. 1A. Typically, applications 103 use GUIs to display and receive information from a user. Pre-defined text in a GUI must be translated into various languages before the applications 103 can be effectively used in different countries. The pre-defined text may be titles, words on buttons and other types of controls presented on a screen, captions that describe information to be entered, etc. The text may consist of a single word, a phrase, or a set of phrases, all of which are referred to herein as “text strings.” When the applications 103 must be localized into a different language, adapters 107 in the visual context translation system 101 extract the text strings 109 from GUI code 105. The adapters 107 use definitions for the GUI components, e.g., screens, controls, etc. in the GUI code 105 to construct a visual context 111 that displays the GUI display without executing the corresponding application 103. Because a GUI screen typically displays more than one text string, logical links 113 are created between the text strings and the visual context 111 to aid in searching for the appropriate GUI screen. It will be appreciated that because the GUI code 105 for the applications 103 may be in different file formats, the system 101 normally contains a separate adapter 107 for each application 103, but common components may be shared among adapters 107. Furthermore, it will be appreciated that definitions for the GUI components may be extracted from the applications 103 in their native form, pre-processed into a form compatible with the visual context 111, and stored as GUI code 105 for subsequent use.

The text strings 109 are sent to translators 115 for translation. The visual context 111 may be sent to the translators as part or, or separate from, the text strings 109. Alternatively, a reference to the visual context 111 may be sent that allows access to the visual context 111 through a network connection, such as a URL (universal resource locator) that causes the visual context 111 to represent the GUI in a browser connected to the Internet.

In one embodiment, the visual context 111 comprises a GUI emulation file structure, such as illustrated in FIGS. 1B-C. A GUI generally presents multiple screens (“views”) to a user, with each view having one or more interactive controls that display and receive information. In a particular embodiment, the controls on a view are presented through applets, and each such applet may have multiple modes, such as read-only, query, etc., with the arrangement of controls in an applet varying by mode.

One embodiment of a structure for a GUI emulation file 120 is shown in FIG. IB. The GUI emulation file 120 contains view data 121, including, for example, an identifier for the view and markup code that specifies common elements for the view, such as font, color, title, etc. An applet entry 123 is present in the GUI emulation file 120 for each applet within the view. The applet entry 123 contains applet data 125 including an applet identifier and the markup code that displays the applet. The applet entry 123 also contains a mode entry 127 for each applet layout that could appear in the view. Each mode entry 127 contains mode data 129 identifying the mode and its markup code, and identifiers and markup code for one or more applet user controls 151 that are part of the applet.

When more than one mode entry 127 exists, the applet data 125 further contains markup code that presents the different applet modes in response to user input. In one embodiment, the view initially presents a default mode for the applet when the GUI emulation file 120 is executed and clicking within the boundaries of the applet causes the markup code in the applet data 125 to show all the applet modes associated with the view. Although only a single view is illustrated as being stored in the GUI emulation file 120 in FIG. 1B, the invention is not so limited.

Furthermore, in alternate embodiments, the various entries in the GUI emulation file 120 may hold pointers to separate files that contain the markup code and other data for the entries. A GUI emulation file structure 130 in FIG. 1C illustrates one arrangement of pointers and files. The GUI emulation file structure 130 is described in terms of HTML (hypertext markup language) code but the invention is not so limited. To avoid obscuring the invention, the portions of the HTML code required to present a view are identified with a common reference number although in typical practice each portion is distinct. It will be appreciated that the various identifiers described below may be any type of value that directly or indirectly uniquely identifies a file, such as a file path name or globally unique identifier (GUID).

A table of contents (TOC) file 131 contains HTML code 133 that presents a list of views to the user when executed. Each entry 135 in the list is hyperlink containing a view identifier. When the user selects the hyperlink, the corresponding view file 137 is invoked. Each view file 137 is based on a template, shown as template file 147. The template file 147 for a view contains HTML code 133 that presents the view and location placeholders 149 that specify where the applets appear in the view.

The placeholders 149 are replaced with applet entries 141 in the view file 137. Each applet entry 141 contains an applet identifier 143 that references an applet file 155. The applet file 155 is also based on a template file 147, which contains the HTML code 133 that presents the applet and placeholders 149 that specify the location of the controls 147 for the applet. If the applet has more than one mode, the applet identifier 143 references the applet file 155 for a default mode for the view, and “wrapper” HTML code 133 in the applet entry 141 presents the alternate modes at the user's discretion. In one embodiment, if the user clicks anywhere within the default applet mode in the view, a frame file 151 is invoked that displays each alternate mode in a frame. The frame file 151 contains HTML code 133 and mode identifiers 153 that reference the applet files 155 for the various modes.

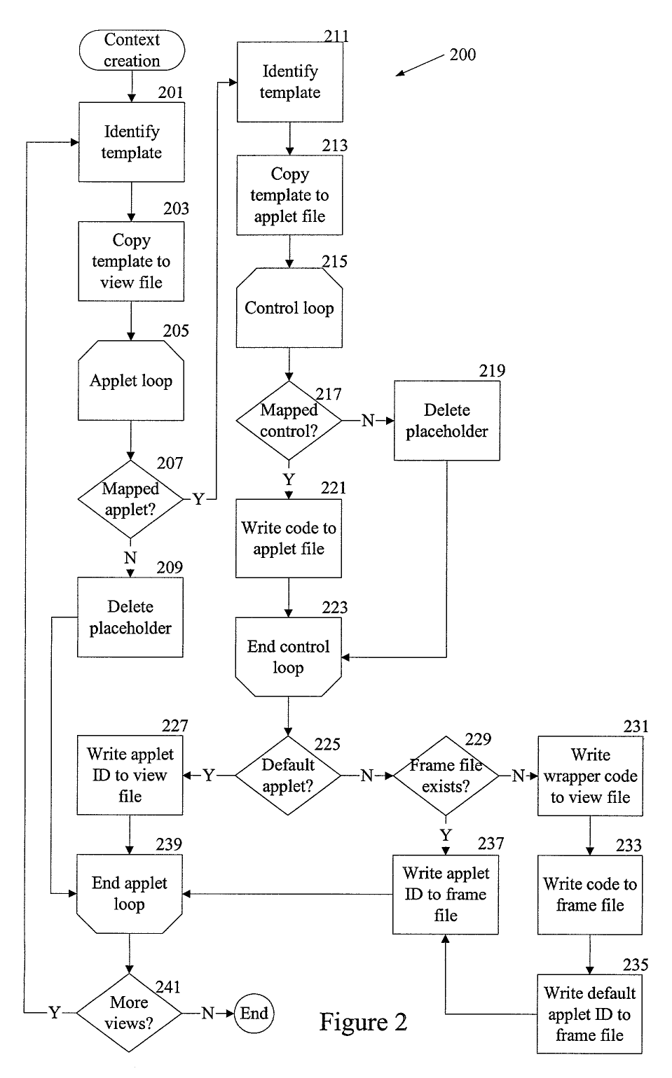

One embodiment of a context creation method 200 performed by the visual context translation system 101 is described with reference to flowchart shown in FIG. 2. The context creation method 200 processes view, applet, and control definitions in the GUI code 105 to create the view 137, applet 155, and frame 151 files described above. It will be appreciated that the method 200 uses standard mass storage input/output commands to open new files and write the data to the files. Furthermore, it is assumed that the appropriate template files 147 are identified by the view and applet definitions, although the template files 147 are not necessarily part of the GUI code 105. Although the process of creating a TOC file is not illustrated, one of skill in the art will readily understand how to create a suitable TOC file to display the views.

For each view in the GUI, the method 200 identifies the corresponding template file (block 201) using the view definition in the GUI, and copies the template code to the view file (block 203). For each placeholder in the view file, the method 200 performs an applet loop starting at block 205. The view definition specifies a placeholder identifier for each applet. If no applet is mapped to the placeholder identifier (block 207), the placeholder is deleted (block 209). If an applet is mapped to the placeholder identifier, the template file for the applet is identified (block 211) and the template is copied to the applet file (block 213). The method 200 processes each placeholder in the applet file starting at block 215. If no control is mapped to the placeholder in the applet definition (block 217), the placeholder is deleted (block 219). If a control is mapped to the placeholder, the code for the control is extracted from the applet definition and written to the applet file at the placeholder location (block 221). Once all controls for an applet have been processed (block 223), the method 200 determines if the view definition specifies the applet mode currently being processed as the default for the view (block 225). If so, the applet identifier for the current mode's applet file is written to the view file at the applet placeholder location (block 227).

If the current applet mode is not specified as the default for the view (block 225), the method 200 determines if the frame file has already been created (block 229). If not, the method 200 writes pre-defined wrapper code to the view file (block 231), and pre-defined frame code (block 233), and the applet identifier for the default mode applet file (block 235) to the frame file. In either case, the applet identifier for the current mode's applet file is written to the frame file at block 237. When all applet modes in the view have been processed (block 239), the method 200 processes the next view, if there are more views in the GUI (block 241).

In practice, the context creation method 200 may constitute one or more programs made up of machine-executable instructions. Describing the method with reference to the flowchart in FIG. 2 enables one skilled in the art to develop such programs, including such instructions to carry out the operations (acts) represented by logical blocks 201 until 241 on suitably configured machines (the processor of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the method illustrated in FIG. 2 without departing from the scope of the invention and that no particular order is implied by the arrangement of blocks shown and described herein.

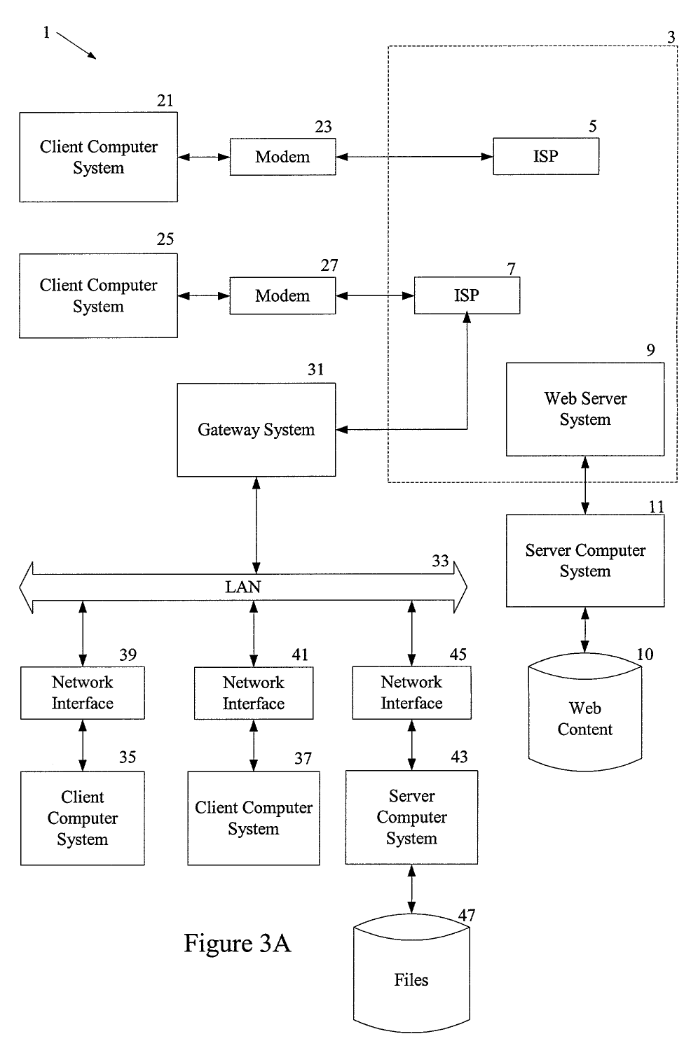

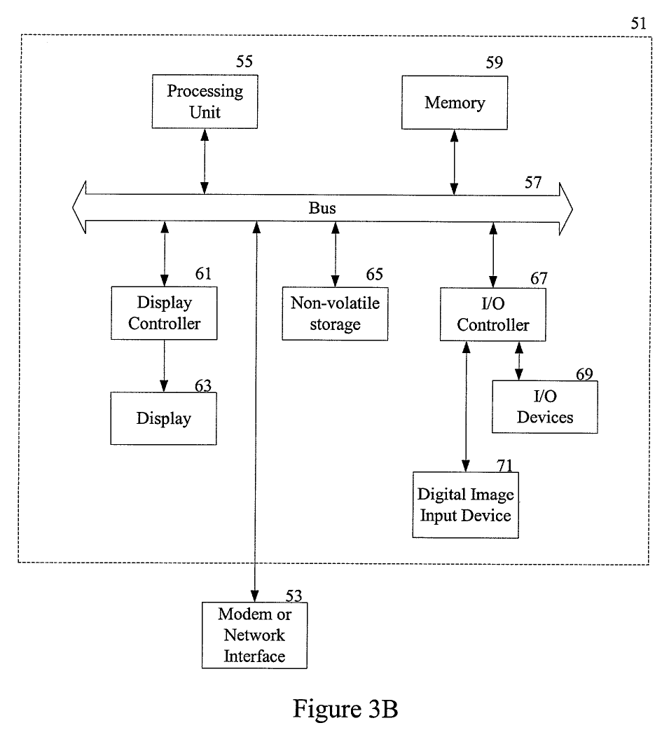

The following description of FIGS. 3A-B is intended to provide an overview of computer hardware and other operating components suitable for implementing the visual context translation system, but is not intended to limit the applicable environments. One of skill in the art will immediately appreciate that the invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 3A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems, such as client computer systems 21, 25, 35, and 37 obtain access to the Internet through the Internet service providers, such as ISPs 5 and 7. Access to the Internet allows users of the client computer systems to exchange information, receive and send e-mails, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 3A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, a network computer, a Web TV system, or other such computer system. Similarly, the ISP 7 provides Internet connectivity for client systems 25, 35, and 37, although as shown in FIG. 3A, the connections are not the same for these three computer systems. Client computer system 25 is coupled through a modem interface 27 while client computer systems 35 and 37 are part of a LAN. While FIG. 3A shows the interfaces 23 and 27 as generically as a “modem,” it will be appreciated that each of these interfaces can be an analog modem, ISDN modem, cable modem, satellite transmission interface (e.g. “Direct PC”), or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 3B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, cable modem, token ring interface, satellite transmission interface (e.g. “Direct PC”), or other interfaces for coupling a computer system to other computer systems. The computer system 51 includes a processing unit 55, which can be a conventional microprocessor such as an Intel Pentium microprocessor or Motorola Power PC microprocessor. Memory 59 is coupled to the processing unit 55 by a bus 57. Memory 59 can be dynamic random access memory (DRAM) and can also include static RAM (SRAM). The bus 57 couples the processing unit 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images =from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the terms “computer-readable medium” and “machine-readable medium” includes any type of storage device that is accessible by the processing unit 55 and also encompasses a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processing unit 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processing unit 55. A Web TV system, which is known in the art, is also considered to be a computer system according to the present invention, but it may lack some of the features shown in FIG. 3B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 65 and causes the processing unit 55 to execute the various acts required by the operating system to input and output data and to store data in memory, including storing files on the non-volatile storage 65.

A visual context that displays a graphical user interface for an application without executing the application has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. For example, although exemplary embodiments of the visual context that use HTML have been described, the invention is suitable for use with any programming language capable of presenting a GUI.

The terminology used in this application with respect to files is meant to include all types of data storage environments, including flat files, relational databases, indexed files, linked lists, and the like. Therefore, it is manifestly intended that this invention be limited only by the following claims and equivalents thereof.

1. A method comprising:
displaying text for translation into a different language, the displaying comprising
constructing a visual context from a definition for a graphical user interface for an application, wherein
the graphical user interface is configured to display a view,
the constructing comprises
automatically extracting executable code corresponding to the view,
the executable code corresponding to the view is extracted from the definition,
automatically writing the executable code corresponding to the view to the visual context, and
the visual context is configured to display the graphical user interface without executing the application; and
displaying multiple modes for an applet within the graphical user interface.

2. (canceled)

3. The method of claim 1, wherein the definition comprises a template for the view and wherein writing the executable code for the view comprises:
copying the template into the visual context.

4. The method of claim 1, wherein the visual context comprises a view file and wherein writing the executable code for the view comprises:
writing the executable code for the view to the view file.

5. The method of claim 1, wherein the graphical user interface displays a control within the view and wherein constructing the visual context further comprises:
extracting executable code for the control from the definition; and
writing the executable code for the control to the visual context.

6. The method of claim 1, wherein the graphical user interface displays the applet within the view and wherein constructing the visual context further comprises:
extracting executable code for the applet from the definition; and
writing the executable code for the applet to the visual context.

7. The method of claim 6, wherein the definition comprises a template for the view that specifies a location within the view to display the applet and wherein writing the executable code for the applet comprises:
associating the executable code for the applet with the location.

8. The method of claim 6, wherein the definition comprises a template for the applet and wherein writing the executable code for the applet comprises:
copying the template for the applet to the visual context.

9. The method of claim 6, wherein the visual context file comprises an applet file and wherein writing the executable code for the applet comprises:
writing the executable code for the applet to the applet file.

10. The method of claim 9, wherein writing the executable code for the applet further comprises:
writing the executable code for each mode for the applet into a separate applet file;
writing executable code that displays the modes for the applet to a plurality of frame files;
referencing each separate applet file from a corresponding frame file; and
writing executable code that invokes the frame files to the visual context.

11. The method of claim 6, wherein the graphical user interface displays a control within the applet and wherein constructing the visual context further comprises:
extracting executable code for the control from the definition; and
writing the executable code for the control to the visual context.

12. The method of claim 11, wherein the definition comprises a template for the applet that specifies a location for a control within the applet and wherein writing the executable code for the control comprises:
associating the executable code for the control with the location.

13. The method of claim 1 further comprising:
associating the visual context with text strings displayed by the graphical user interface.

14. The method of claim 1 further comprising:
providing a reference to the visual context to a translator; and
executing the visual context when the reference is invoked.

15. The method of claim 1 further comprising:
providing the visual context to a translator for execution.

16. A computer-program product comprising;
a machine-readable medium having executable instructions to cause a machine to execute
a method comprising
constructing a visual context from a definition for a graphical user interface for an application, wherein
the graphical user interface is configured to display a view,
the constructing comprises
automatically extracting executable code corresponding to the view, and
automatically writing the executable code corresponding to the view to the visual context,
the executable code corresponds to the view is extracted from the definition, and
the visual context is configured to display the graphical user interface; and
displaying multiple modes for an applet within the graphical user interface.

17. (canceled)

18. The machine-readable medium of claim 16, wherein the definition comprises a template for the view and wherein writing the executable code for the view comprises:
copying the template into the visual context.

19. The machine-readable medium of claim 16, wherein the visual context comprises a view file and wherein writing the executable code for the view comprises:
writing the executable code for the view to the view file.

20. The machine-readable medium of claim 16, wherein the graphical user interface displays a control within the view and wherein constructing the visual context further comprises:
extracting executable code for the control from the definition; and
writing the executable code for the control to the visual context.

21. The machine-readable medium of claim 16, wherein the graphical user interface displays the applet within the view and wherein constructing the visual context further comprises:
extracting executable code for the applet from the definition; and
writing the executable code for the applet to the visual context.

22. The machine-readable medium of claim 21, wherein the definition comprises a template for the view that specifies a location within the view to display the applet and wherein writing the executable code for the applet comprises:
associating the executable code for the applet with the location.

23. The machine-readable medium of claim 21, wherein the definition comprises a template for the applet and wherein writing the executable code for the applet comprises:
copying the template for the applet to the visual context.

24. The machine-readable medium of claim 21, wherein the visual context file comprises an applet file and wherein writing the executable code for the applet comprises:
writing the executable code for the applet to the applet file.

25. The machine-readable medium of claim 24, wherein writing the executable code for the applet further comprises:
writing the executable code for each mode for the applet into a separate applet file;
writing executable code that displays the modes for the applet to a plurality of frame files;
referencing each separate applet file from a corresponding frame file; and
writing executable code that invokes the frame files to the visual context.

26. The machine-readable medium of claim 21, wherein the graphical user interface displays a control within the applet and wherein constructing the visual context further comprises:
extracting executable code for the control from the definition; and
writing the executable code for the control to the visual context.

27. The machine-readable medium of claim 26, wherein the definition comprises a template for the applet that specifies a location for a control within the applet and wherein writing the executable code for the control comprises:
associating the executable code for the control with the location.

28. The machine-readable medium of claim 16, wherein the method further comprises:
associating the visual context with text strings displayed by the graphical user interface.

29. The machine-readable medium of claim 16, wherein the method further comprises:
providing a reference to the visual context to a translator; and
executing the visual context when the reference is invoked.

30. The machine-readable medium of claim 16, wherein the method further comprises:
providing the visual context to a translator for execution.

31. A system comprising:
a memory;
a display;
a processor coupled to the memory via a bus and coupled to the display; and
a visual context creation process executed from the memory by the processor, wherein
the visual context creation process is configured to cause the processor to construct a visual context from a definition for a graphical user interface for an application, wherein
the graphical user interface is configured to display a view,
the visual context creation process configured to cause the processor to construct a visual context is configured to automatically extract executable code corresponding to the view,
the executable code corresponds to the view is extracted from the definition,
automatically write the executable code corresponding to the view to the visual context, and
the visual context is configured to display the graphical user interface,
the visual context creation process is configured to cause the display of the graphical user interface without executing the application via the display, and
the visual context creation process is configured to cause the display of multiple modes for an applet within the graphical user interface via the display.

32. (canceled)

33. The system of claim 31, wherein the definition comprises a template for the view and wherein, when writing the executable code for the view, the visual context creation process further causes the processor to copy the template into the visual context.

34. The system of claim 31, wherein the visual context comprises a view file and wherein, when writing the executable code for the view, the visual context creation process further causes the processor to write the executable code for the view to the view file.

35. The system of claim 31, wherein the graphical user interface displays a control within the view and wherein, when constructing the visual context, the visual context creation process further causes the processor to extract executable code for the control from the definition and write the executable code for the control to the visual context.

36. The system of claim 31, wherein, when constructing the visual context, the visual context creation process further causes the processor to extract executable code for the applet from the definition and write the executable code for the applet to the visual context.

37. The system of claim 36, wherein the definition comprises a template for the view that specifies a location within the view to display the applet and wherein, when writing the executable code for the applet, the visual context creation process further causes the processor to associate the executable code for the applet with the location.

38. The system of claim 36, wherein the definition comprises a template for the applet and wherein, when writing the executable code for the applet, the visual context creation process further causes the processor to copy the template for the applet to the visual context.

39. The system of claim 36, wherein the visual context file comprises an applet file and wherein, when writing the executable code for the applet, the visual context creation process further causes the processor to write the executable code for the applet to the applet file.

40. The system of claim 39, wherein, when writing the executable code for the applet, the visual context creation process further causes the processor to further write the executable code for each mode for the applet into a separate applet file, write executable code that displays the modes for the applet to a plurality of frame files, reference each separate applet file from a corresponding frame file and write executable code that invokes the frame files to the visual context.

41. The system of claim 36, wherein the graphical user interface displays a control within the applet and wherein, when constructing the visual context, the visual context creation process further causes the processor to extract executable code for the control from the definition, and write the executable code for the control to the visual context.

42. The system of claim 41, wherein the definition comprises a template for the applet that specifies a location for a control within the applet and wherein, when writing the executable code for the control, the visual context creation process further causes the processor to associate the executable code for the control with the location.

43. The system of claim 31, wherein the visual context creation process further causes the processor to associate the visual context with text strings displayed by the graphical user interface.

44. The system of claim 31, wherein the visual context creation process further causes the processor to provide a reference to the visual context to a translator and execute the visual context when the reference is invoked.

45. The system of claim 31, wherein the visual context creation process further causes the processor to provide the visual context to a translator for execution.

46. A computer-program product comprising:
machine-readable medium having an emulation file structure comprising
a view entry containing view data representing executable code configured to display a view in a graphical user interface, wherein the graphical user interface is configured to display a view;
an applet entry containing applet data referencing executable code that displays multiple modes for an applet within the view defined by the view entry.
wherein
the applet data in the applet entry identifies an applet file containing the executable code that displays the applet, and
the executable code corresponds to the view is extracted from the definition; and
a control entry containing control data referencing executable code that displays a control within the applet defined by the applet entry.

47. (canceled)

48. The machine-readable medium of claim 46, wherein the applet entry comprises:
a mode entry containing mode data referencing executable code that displays a particular mode of the applet within a frame, the mode entry further containing frame data that references executable code that invokes the frame.

49. The machine-readable medium of claim 48, wherein the mode data in the mode entry identifies a frame file containing the executable code that displays the particular mode.
